(19) United States
(12) Patent Application Publication
(10) Pub. No.: US 2014/0322627 A1
(43) Pub. Date: Oct. 30, 2014

(54) FUEL CELL

(71) Applicant: HONDA MOTOR CO., LTD., Tokyo (JP)

(72) Inventors: Shuhei GOTO, UTSUNOMIYA-SHI (JP); Kentaro ISHIDA, UTSUNOMIYA-SHI (JP); Naoki YAMANO, UTSUNOMIYA-SHI (JP); Hiroyuki TANAKA, UTSUNOMIYA-SHI (JP)

(73) Assignee: HONDA MOTOR CO., LTD., Tokyo (JP)

(21) Appl. No.: 14/260,954

(22) Filed: Apr. 24, 2014

(30) Foreign Application Priority Data
Apr. 26, 2013 (JP) 2013-093203

(51) Int. Cl. H01M 8/02; H01M 8/10

(52) U.S. Cl. CPC H01M 8/0247; H01M 8/10; H01M 2008/1095
USPC 429/479

(57) ABSTRACT

A power generation unit of a fuel cell includes a first metal separator, a first membrane electrode assembly, a second metal separator, a second membrane electrode assembly, and a third metal separator. The first metal separator includes first ridges for positioning the first membrane electrode assembly. The second metal separator includes second ridges for limiting movement of the first membrane electrode assembly.

### CROSS-REFERENCE TO RELATED APPLICATION

This application is based upon and claims the benefit of priority from Japanese Patent Application No. 2013-093203 filed on Apr. 26, 2013, the contents of which are incorporated herein by reference.

### BACKGROUND OF THE INVENTION

1. Field of the Invention

The present invention relates to a fuel cell formed by stacking an electrolyte electrode assembly between a first separator and a second separator. The electrolyte electrode assembly includes a pair of electrodes and an electrolyte interposed between the electrodes.

2. Description of the Related Art

In general, a solid polymer electrolyte fuel cell employs a solid polymer electrolyte membrane. The solid polymer electrolyte membrane is a solid polymer ion exchange membrane. The fuel cell includes a membrane electrode assembly (MEA) where an anode is provided on one side of the solid polymer electrolyte membrane, and a cathode is provided on the other side of the solid polymer electrolyte membrane. The membrane electrode assembly is sandwiched between separators (bipolar plates). In use, a predetermined number of fuel cells are stacked together to form a fuel cell stack. For example, the fuel cell stack is mounted in a vehicle as an in-vehicle fuel cell stack.

A fuel gas flow field, an oxygen-containing gas flow field, and a coolant flow field are formed in the fuel cell, and these flow fields need to be sealed in an air-tight (liquid-tight) manner. For this purpose, the membrane electrode assembly and the separators need to be positioned accurately. For example, a fuel cell disclosed in Japanese Laid-Open Patent Publication No. 2004-265824 is known.

The fuel cell includes a membrane electrode assembly and a pair of separators sandwiching the membrane electrode assembly. A seal member formed integrally with one of the separators has a flat section facing one of the electrodes, and a plurality of projections for positioning the outer end of the membrane electrode assembly are provided in the flat section.

### SUMMARY OF THE INVENTION

In some cases, deformation occurs at edges of the membrane electrode assembly. In particular, in a resin frame equipped MEA having a resin frame member provided integrally with the outer end of the membrane electrode assembly, warpage tends to occur easily in the resin frame member. Therefore, at the time of positioning the membrane electrode assembly using the projections provided on one of the separators, the membrane electrode assembly may move beyond the projections due to warpage at the end of the membrane electrode assembly. Consequently, the membrane electrode assembly and the separators may not be positioned relative to one another accurately.

The present invention has been made to solve the problem of this type, and an object of the present invention is to provide a fuel cell having simple structure in which it is possible to position a membrane electrode assembly and separators relative to each other accurately and reliably.

The present invention relates to a fuel cell formed by stacking an electrolyte electrode assembly between a first separator and a second separator. The electrolyte electrode assembly includes a pair of electrodes and an electrolyte interposed between the electrodes. In the fuel cell, the first separator includes a first ridge protruding toward the second separator, for positioning the electrolyte electrode assembly. The second separator includes a second ridge protruding toward the first separator, for limiting movement of the electrolyte electrode assembly.

In the present invention, the first ridge protruding toward the second separator is provided in the first separator, and the second ridge protruding toward the first separator is provided in the second separator. In the structure, when the electrolyte electrode assembly is being positioned by the first ridge, even if the electrolyte electrode assembly is about to move beyond the first ridge due to warpage or the like at the end of the electrolyte electrode assembly, the movement is blocked by abutment against the second ridge.

Thus, with the simple structure, it becomes possible to position the electrolyte electrode assembly and the separators relative to one another accurately and reliably.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an exploded perspective view showing main components of a power generation unit of a fuel cell according to an embodiment of the present invention;

FIG. 2 is a cross sectional view showing the power generation unit, taken along a line II-II in FIG. 1;

FIG. 3 is an exploded view showing main components of the power generation unit;

FIG. 4 is a view showing one surface of a first metal separator of the power generation unit;

FIG. 5 is a view showing one surface of a second metal separator of the power generation unit;

FIG. 6 is a view showing one surface of a third metal separator of the power generation unit;

FIG. 7 is a view showing one surface of a first membrane electrode assembly of the power generation unit;

FIG. 8 is a view showing the other surface of the first membrane electrode assembly;

FIG. 9 is a view showing one surface of a second membrane electrode assembly of the power generation unit; and

FIG. 10 is a view showing the other surface of the second membrane electrode assembly.

### DESCRIPTION OF THE PREFERRED EMBODIMENTS

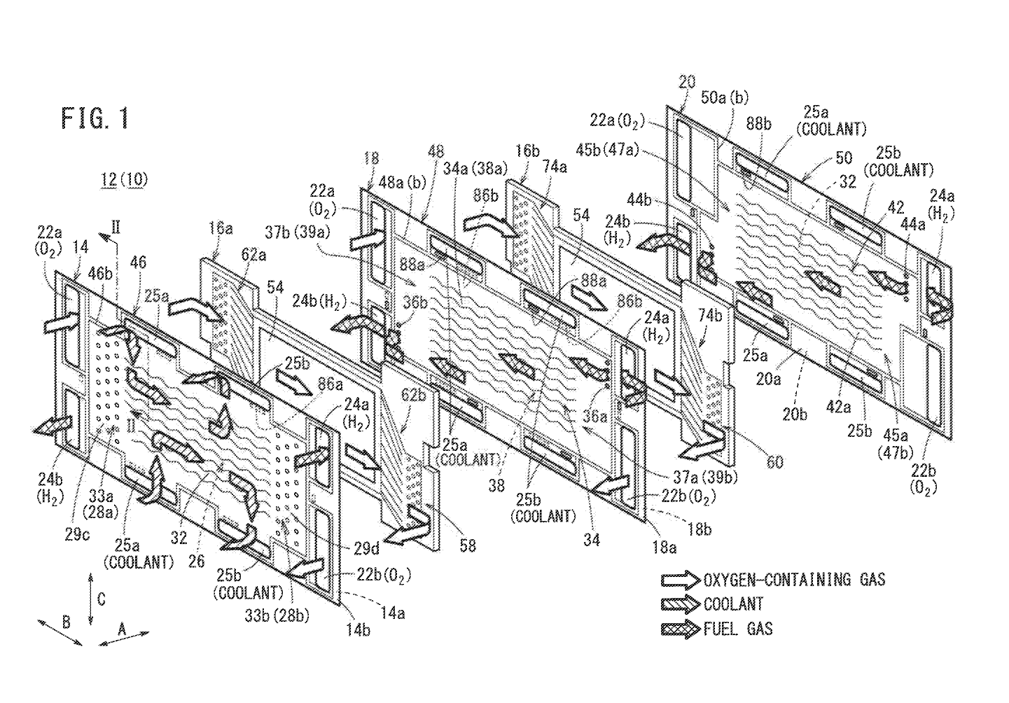

As shown in FIGS. 1 to 3, a fuel cell 10 according to an embodiment of the present invention includes a power generation unit 12. A plurality of power generation units 12 are stacked together in a horizontal direction indicated by an arrow A or in a vertical direction indicated by an arrow C to form a fuel cell stack. The power generation unit 12 includes a first metal separator 14, a first membrane (electrolyte) electrode assembly (MEA) 16a, a second metal separator 18, a second membrane (electrolyte) electrode assembly (MEA) 16b, and a third metal separator 20.

For example, the first metal separator 14, the second metal separator 18, and the third metal separator 20 are laterally elongated metal plates such as steel plates, stainless steel plates, aluminum plates, plated steel sheets, or metal plates having anti-corrosive surfaces by surface treatment. For example, the first metal separator 14, the second metal separator 18, and the third metal separator 20 have rectangular planar surfaces, and are formed by corrugating metal thin plates by press forming to have a corrugated shape in cross section. Instead of the first metal separator 14, the second metal separator 18, and the third metal separator 20, carbon separators may be used.

As shown in FIG. 1, at one end of a power generation unit 12 in a longitudinal direction indicated by an arrow B, an oxygen-containing gas supply passage 22a for supplying an oxygen-containing gas and a fuel gas discharge passage 24b for discharging a fuel gas such as a hydrogen-containing gas are provided. The oxygen-containing gas supply passage 22a and the fuel gas discharge passage 24b extend through the power generation unit 12 in the direction indicated by the arrow A.

At the other end of the power generation unit 12 in the longitudinal direction indicated by the arrow B, a fuel gas supply passage 24a for supplying the fuel gas and an oxygen-containing gas discharge passage 22b for discharging the oxygen-containing gas are provided. The fuel gas supply passage 24a and the oxygen-containing gas discharge passage 22b extend through the power generation unit 12 in the direction indicated by the arrow A.

At both ends of the power generation unit 12 in a lateral direction indicated by the arrow C, a pair of coolant supply passages 25a for supplying a coolant are provided on a side closer to the oxygen-containing gas supply passage 22a. At both ends of the power generation unit 12 in the lateral direction indicated by the arrow C, a pair of coolant discharge passages 25b for discharging the coolant are provided on a side closer to the fuel gas supply passage 24a. The coolant supply passages 25a and the coolant discharge passages 25b extend through the power generation unit 12 in the direction indicated by the arrow A.

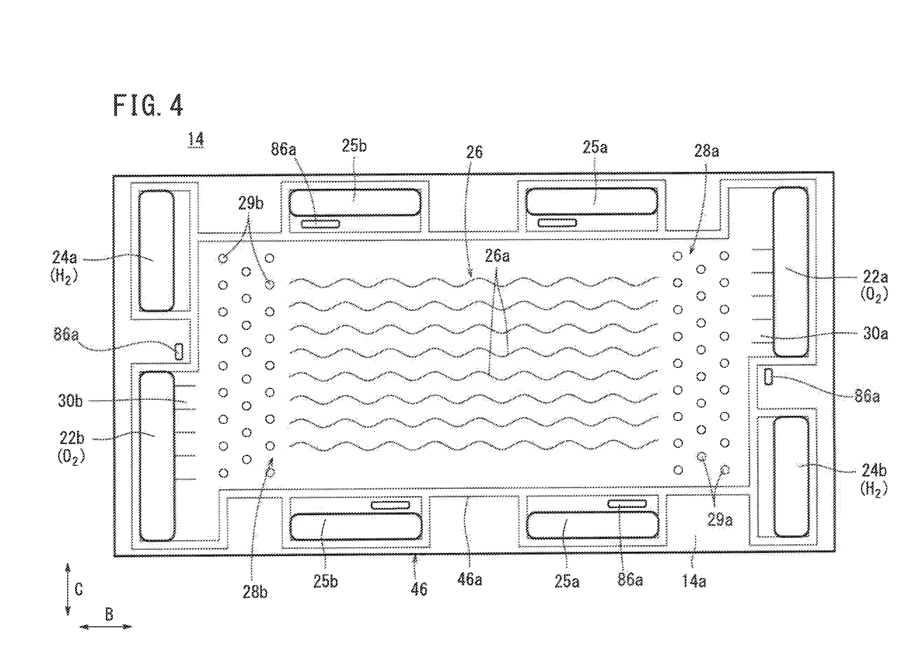

As shown in FIG. 4, the first metal separator 14 has a first oxygen-containing gas flow field 26 on its surface 14a facing the first membrane electrode assembly 16a. The first oxygen-containing gas flow field 26 is connected to the oxygen-containing gas supply passage 22a and the oxygen-containing gas discharge passage 22b.

The first oxygen-containing gas flow field 26 includes a plurality of wavy flow grooves (or straight flow grooves) 26a extending in the direction indicated by the arrow B. An inlet buffer 28a is provided adjacent to the inlet of the first oxygen-containing gas flow field 26 and an outlet buffer 28b is provided adjacent to the outlet of the first oxygen-containing gas flow field 26, at positions outside the power generation area. A plurality of bosses 29a are provided in the inlet buffer 28a, and a plurality of bosses 29b are provided in the outlet buffer 28b. The bosses 29a, 29b can be formed in various shapes such as a circular shape, an oval shape, and a straight line shape. The bosses of resin frame members described later can be formed in various shapes as well.

A plurality of inlet connection grooves 30a as part of a bridge section are formed between the inlet buffer 28a and the oxygen-containing gas supply passage 22a, and a plurality of outlet connection grooves 30b as part of a bridge section are formed between the outlet buffer 28b and the oxygen-containing gas discharge passage 22b.

As shown in FIG. 1, a coolant flow field 32 is formed on a surface 14b of the first metal separator 14. The coolant flow field 32 is connected to the pair of coolant supply passages 25a and the pair of coolant discharge passages 25b. The coolant flow field 32 is formed by stacking the back surface of the first oxygen-containing gas flow field 26 and the back surface of a second fuel gas flow field 42 to be described later.

An inlet buffer 33a is provided adjacent to the inlet of the coolant flow field 32 and an outlet buffer 33b is provided adjacent to the outlet of the coolant flow field 32, outside the power generation area. The inlet buffer 33a and the outlet buffer 33b are provided on the back surfaces of the inlet buffer 28a and the outlet buffer 28b on the oxygen-containing gas side. A plurality of bosses 29c are provided in the inlet buffer 33a, and a plurality of bosses 29d are provided in the outlet buffer 33b.

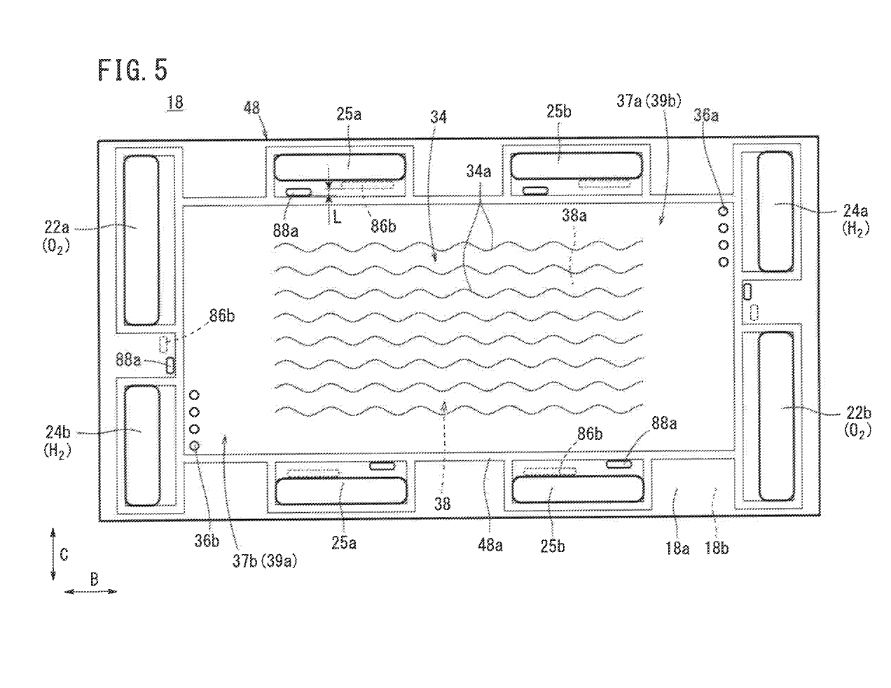

As shown in FIG. 5, the second metal separator 18 has a first fuel gas flow field 34 on its surface 18a facing the first membrane electrode assembly 16a. The first fuel gas flow field 34 is connected to the fuel gas supply passage 24a and the fuel gas discharge passage 24b. The first fuel gas flow field 34 includes a plurality of wavy flow grooves (or straight flow grooves) 34a extending in the direction indicated by the arrow B.

A plurality of supply holes 36a are formed adjacent to the fuel gas supply passage 24a, and a plurality of discharge holes 36b are formed adjacent to the fuel gas discharge passage 24b. Flat sections 37a, 37b are provided adjacent to the inlet and the outlet of the first fuel gas flow field 34, respectively.

As shown in FIGS. 1 and 5, the second metal separator 18 has a second oxygen-containing gas flow field 38 on its surface 18b facing the second membrane electrode assembly 16b. The second oxygen-containing gas flow field 38 is connected to the oxygen-containing gas supply passage 22a and the oxygen-containing gas discharge passage 22b. The second oxygen-containing gas flow field 38 includes a plurality of wavy flow grooves (or straight flow grooves) 38a extending in the direction indicated by the arrow B.

Flat sections 39a, 39b are provided adjacent to the inlet and the outlet of the second oxygen-containing gas flow field 38, respectively. The flat sections 39a, 39b are formed on the back surfaces of the flat sections 37a, 37b. A plurality of inlet connection grooves (not shown) as part of a bridge section are formed between the flat section 39a and the oxygen-containing gas supply passage 22a. A plurality of outlet connection grooves (not shown) as part of a bridge section are formed between the flat section 39b and the oxygen-containing gas discharge passage 22b.

As shown in FIG. 1, the third metal separator 20 has a second fuel gas flow field 42 on its surface 20a facing the second membrane electrode assembly 16b. The second fuel gas flow field 42 is connected to the fuel gas supply passage 24a and the fuel gas discharge passage 24b. The second fuel gas flow field 42 includes a plurality of wavy flow grooves (or straight flow grooves) 42a extending in the direction indicated by the arrow B.

A plurality of supply holes 44a are formed adjacent to the fuel gas supply passage 24a, and a plurality of discharge holes 44b are formed adjacent to the fuel gas discharge passage 24b. The supply holes 44a are positioned on the inside of the supply holes 36a of the second metal separator 18 (on the side closer to the fuel gas flow field). The discharge holes 44b are positioned on the inside of the discharge holes 36b of the second metal separator 18 (on the side closer to the fuel gas flow field). Flat sections 45a, 45b are provided adjacent to the inlet and the outlet of the second fuel gas flow field 42, respectively.

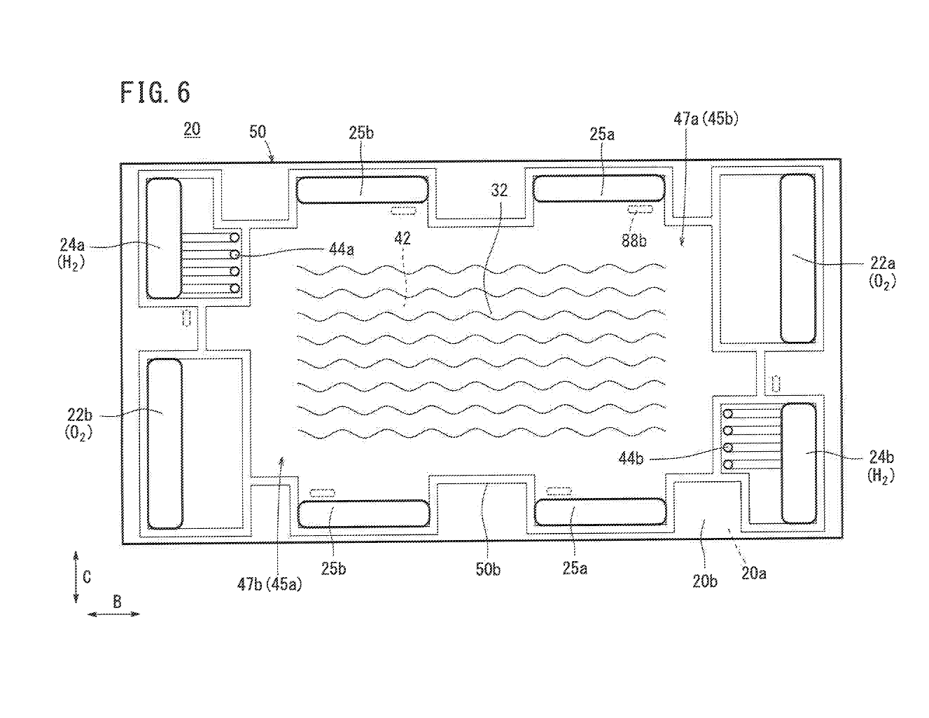

As shown in FIG. 6, a coolant flow field 32 is formed partially on a surface 20b of the third metal separator 20, on the back surface of the second fuel gas flow field 42. The surface 20b of the third metal separator 20 is stacked on the surface 14b of the first metal separator 14 adjacent to the third metal separator 20 to form the coolant flow field 32 between the third metal separator 20 and the first metal separator 14.

Flat sections 47a, 47b are provided adjacent to the inlet and the outlet of the coolant flow field 32. The flat sections 47b, 47a are provided on the back surfaces of the flat sections 45a, 45b, respectively.

As shown in FIG. 1, a first seal member 46 is formed integrally with the surfaces 14a, 14b of the first metal separator 14, around the outer end of the first metal separator 14. A second seal member 48 is formed integrally with the surfaces 18a, 18b of the second metal separator 18, around the outer end of the second metal separator 18. A third seal member 50 is formed integrally with the surfaces 20a, 20b of the third metal separator 20, around the outer end of the third metal separator 20.

Each of the first seal member 46, the second seal members 48, and the third seal member 50 is made of seal material, cushion material, or packing material such as an EPDM (ethylene propylene diene monomer) rubber, an NBR (nitrile butadiene rubber), a fluoro rubber, a silicone rubber, a fluorosilicone rubber, a Butyl rubber, a natural rubber, a styrene rubber, a chloroprene rubber, or an acrylic rubber.

As shown in FIG. 4, the first seal member 46 includes a first ridge seal 46a on the surface 14a of the first metal separator 14. The first ridge seal 46a surrounds the oxygen-containing gas supply passage 22a, the oxygen-containing gas discharge passage 22b, and the first oxygen-containing gas flow field 26, while allowing the oxygen-containing gas supply passage 22a and the oxygen-containing gas discharge passage 22b to be connected to the first oxygen-containing gas flow field 26. As shown in FIG. 1, the first seal member 46 includes a second ridge seal 46b on the surface 14b of the first metal separator 14. The second ridge seal 46b surrounds the coolant supply passages 25a, the coolant discharge passages 25b, and the coolant flow field 32, while allowing the coolant supply passages 25a and the coolant discharge passages 25b to be connected to the coolant flow field 32.

As shown in FIG. 5, the second seal member 48 includes a first ridge seal 48a on the surface 18a of the second metal separator 18. The first ridge seal 48a surrounds the supply holes 36a and the discharge holes 36b, and the first fuel gas flow field 34, while allowing the supply holes 36a and the discharge holes 36b to be connected to the first fuel gas flow field 34.

As shown in FIG. 1, the second seal member 48 includes a second ridge seal 48b on the surface 18b of the second metal separator 18. The second ridge seal 48b surrounds the oxygen-containing gas supply passage 22a, the oxygen-containing gas discharge passage 22b, and the second oxygen-containing gas flow field 38, while allowing the oxygen-containing gas supply passage 22a and the oxygen-containing gas discharge passage 22b to be connected to the second oxygen-containing gas flow field 38.

The third seal member 50 includes a first ridge seal 50a on the surface 20a of the third metal separator 20. The first ridge seal 50a surrounds the supply holes 44a, the discharge holes 44b, and the second fuel gas flow field 42, while allowing the supply holes 44a and the discharge holes 44b to be connected to the second fuel gas flow field 42.

As shown in FIG. 6, the third seal member 50 includes a second ridge seal 50b on the surface 20b of the third metal separator 20. The second ridge seal 50b surrounds the coolant supply passages 25a, the coolant discharge passages 25b, and the coolant flow field 32, while allowing the coolant supply passages 25a and the coolant discharge passages 25b to be connected to the coolant flow field 32.

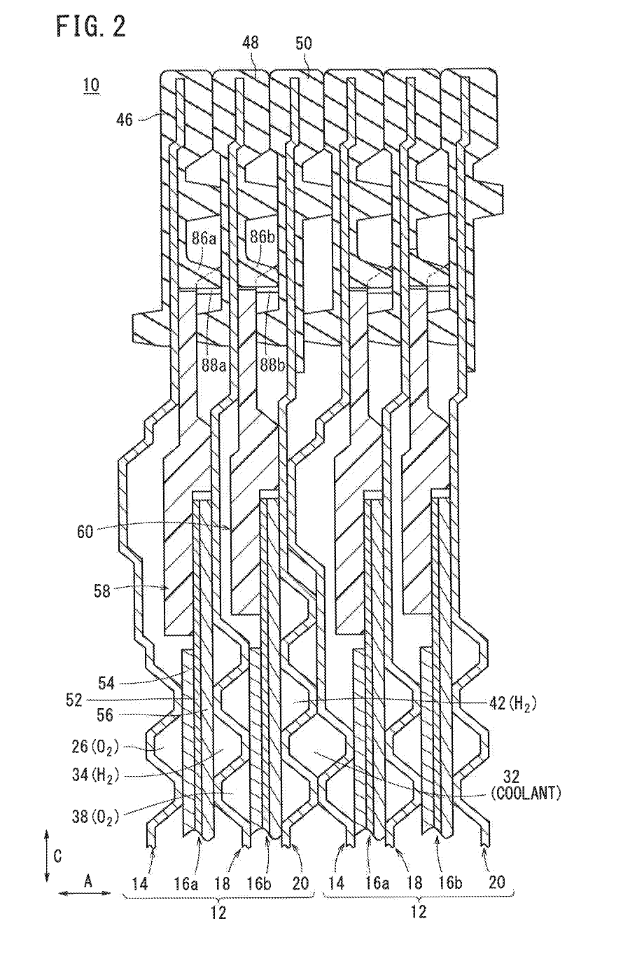

As shown in FIG. 2, each of the first membrane electrode assembly 16a and the second membrane electrode assembly 16b includes a solid polymer electrolyte membrane 52, and a cathode 54 and an anode 56 sandwiching the solid polymer electrolyte membrane 52. The solid polymer electrolyte membrane 52 is formed by impregnating a thin membrane of perfluorosulfonic acid with water, for example. The surface size (surface area) of the cathode 54 is smaller than the surface sizes (surface areas) of the anode 56 and the solid polymer electrolyte membrane 52 to form an MEA having different sizes of components. It should be noted that the cathode 54, the anode 56, and the solid polymer electrolyte membrane 52 may have the same surface size. Further, the surface size of the anode 56 may be smaller than the surface sizes of the cathode 54 and the solid polymer electrolyte membrane 52.

Each of the cathode 54 and the anode 56 has a gas diffusion layer (not shown) such as a carbon paper, and an electrode catalyst layer (not shown) of platinum alloy supported on porous carbon particles. The carbon particles are deposited uniformly on the surface of the gas diffusion layer. The electrode catalyst layer of the cathode 54 and the electrode catalyst layer of the anode 56 are fixed to both surfaces of the solid polymer electrolyte membrane 52, respectively.

As shown in FIGS. 1 to 3, in the first membrane electrode assembly 16a, a first resin frame member (resin frame member) 58 is formed integrally with the outer marginal portion of the solid polymer electrolyte membrane 52, outside the outer end of the cathode 54, e.g., by injection molding. Alternatively, a resin frame member which is produced beforehand as a separate member may be joined to the solid polymer electrolyte membrane 52.

In the second membrane electrode assembly 16b, a second resin frame member (resin frame member) 60 is formed integrally with the outer marginal portion of the solid polymer electrolyte membrane 52, outside the outer end of the cathode 54, e.g., by injection molding. Alternatively, a resin frame member which is produced beforehand as a separate member may be joined to the solid polymer electrolyte membrane 52.

As the resin material of the first resin frame member 58 and the second resin frame member 60, for example, in addition to general purpose plastic having electrical insulating properties, engineering plastic, super engineering plastic or the like is adopted. For example, films or the like may be used as the first resin frame member 58 and the second resin frame member 60.

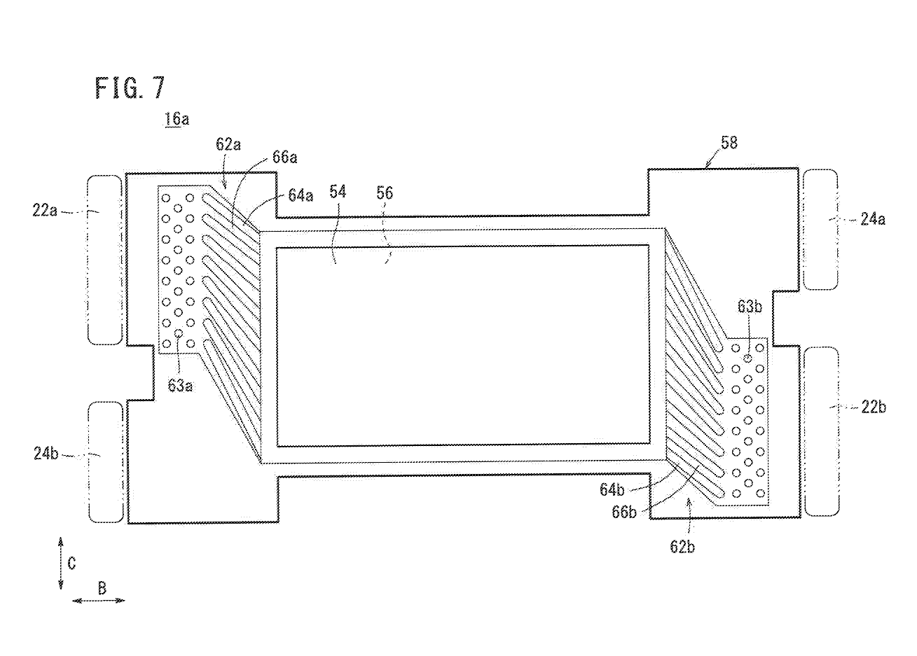

As shown in FIG. 7, on a surface of the first resin frame member 58 where the cathode 54 is provided, an inlet buffer 62a is provided between the oxygen-containing gas supply passage 22a and the inlet of the first oxygen-containing gas flow field 26 (outside the power generation area), and an outlet buffer 62b is provided between the oxygen-containing gas discharge passage 22b and the outlet of the first oxygen-containing gas flow field 26 (outside the power generation area). The power generation area herein means an area where electrolyte catalyst layers are provided on both sides of the solid polymer electrolyte membrane 52.

The inlet buffer 62a includes a plurality of linear ridges 64a formed integrally with the first resin frame member 58, and an inlet guide path 66a is formed between the ridges 64a. The outlet buffer 62b includes a plurality of linear ridges 64b formed integrally with the first resin frame member 58, and an outlet guide path 66b is formed between the ridges 64b. A plurality of bosses 63a, 63b are formed in the inlet buffer 62a and the outlet buffer 62b, respectively. The inlet buffer 62a and the outlet buffer 62b may include only linear ridges or only bosses.

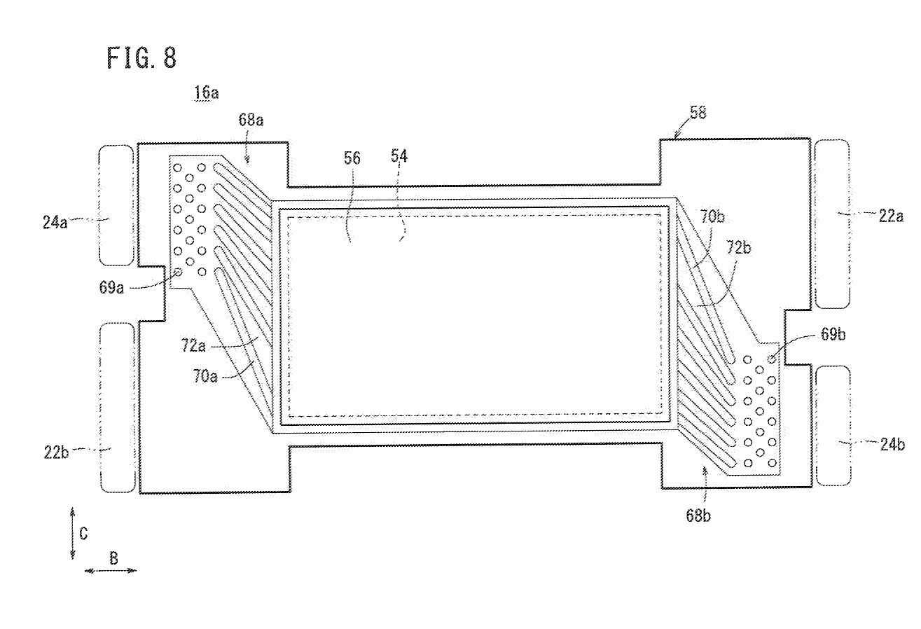

As shown in FIG. 8, on a surface of the first resin frame member 58 where the anode 56 is provided, an inlet buffer 68a is provided between the fuel gas supply passage 24a and the first fuel gas flow field 34 (outside the power generation area), and an outlet buffer 68b is provided between the fuel gas discharge passage 24b and the first fuel gas flow field 34 (outside the power generation area).

The inlet buffer 68a includes a plurality of linear ridges 70a, and an inlet guide path 72a is formed between the ridges 70a. The outlet buffer 68b includes a plurality of linear ridges 70b, and an outlet guide path 72b is formed between the ridges 70b. A plurality of bosses 69a, 69b are formed in the inlet buffer 68a and the outlet buffer 68b, respectively.

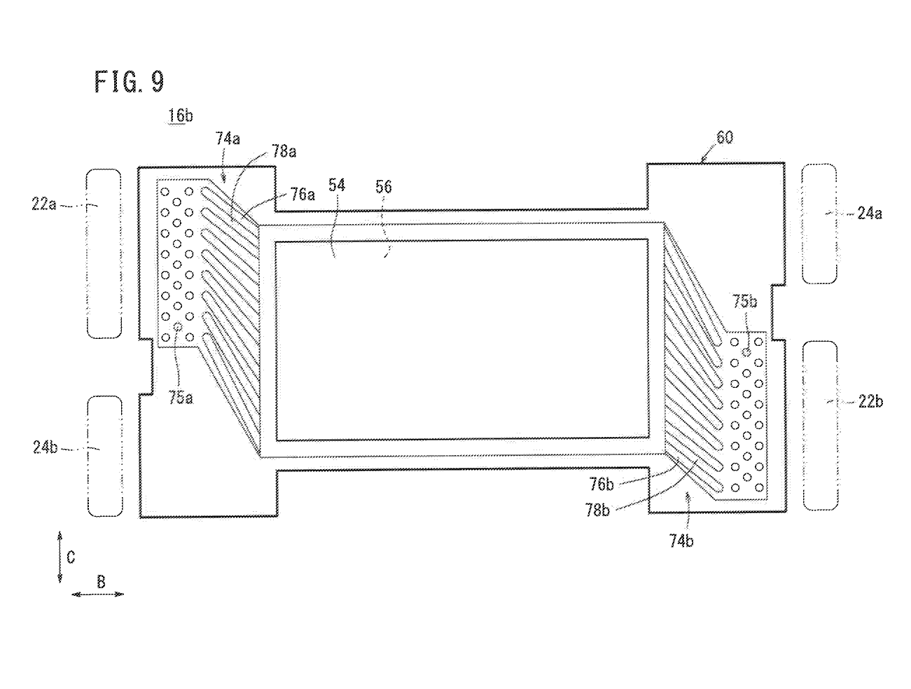

As shown in FIG. 9, on a surface of the second resin frame member 60 where the cathode 54 is provided, an inlet buffer 74a is provided between the oxygen-containing gas supply passage 22a and the second oxygen-containing gas flow field 38 (outside the power generation area), and an outlet buffer 74b is provided between the oxygen-containing gas discharge passage 22b and the second oxygen-containing gas flow field 38 (outside the power generation area).

The inlet buffer 74a includes a plurality of linear ridges 76a, and an inlet guide path 78a is formed between the ridges 76a. The outlet buffer 74b includes a plurality of linear ridges 76b, and an outlet guide path 78b is formed between the ridges 76b. A plurality of bosses 75a, 75b are formed in the inlet buffer 74a and the outlet buffer 74b, respectively.

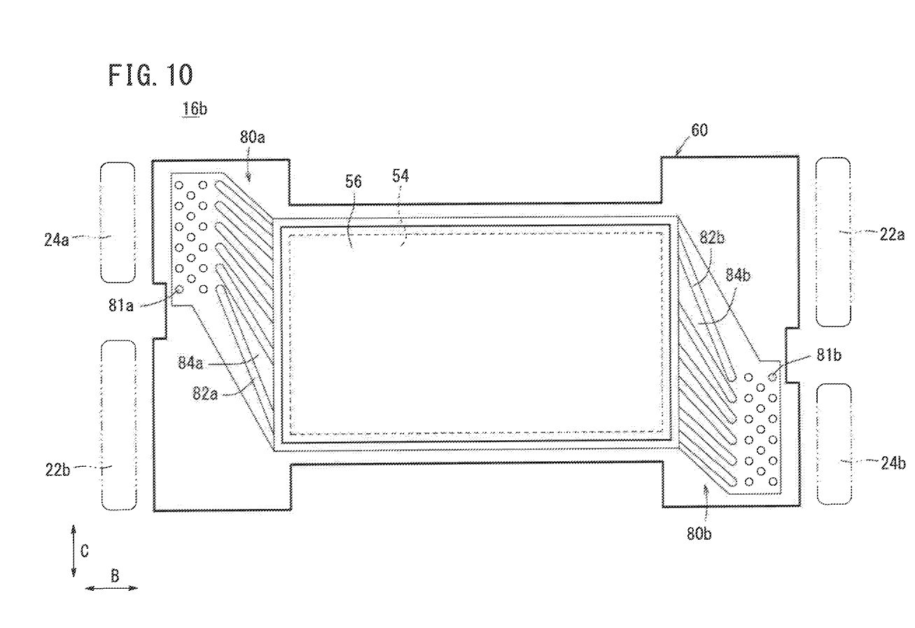

As shown in FIG. 10, on a surface of the second resin frame member 60 where the anode 56 is provided, an inlet buffer 80a is provided between the fuel gas supply passage 24a and the second fuel gas flow field 42 (outside the power generation area), and an outlet buffer 80b is provided between the fuel gas discharge passage 24b and the second fuel gas flow field 42 (outside the power generation area).

The inlet buffer 80a includes a plurality of linear ridges 82a, and an inlet guide path 84a is formed between the ridges 82a. The outlet buffer 80b includes a plurality of linear ridges 82b, and an outlet guide path 84b is formed between the ridges 82b. A plurality of bosses 81a, 81b are formed in the inlet buffer 80a and the outlet buffer 80b, respectively.

When the power generation units 12 are stacked together, the coolant flow field 32 is formed between the first metal separator 14 of one of the adjacent power generation units 12 and the third metal separator 20 of the other of the adjacent power generation units 12.

In the embodiment of the present invention, first ridges 86a, 86b for positioning the first membrane electrode assembly 16a and the second membrane electrode assembly 16b are provided in the surface 14a of the first metal separator 14 and the surface 18b of the second metal separator 18, respectively. Further, second ridges 88a, 88b for limiting movement of the first membrane electrode assembly 16a and the second membrane electrode assembly 16b are provided in the surface 18a of the second metal separator 18 and the surface 20a of the third metal separator 20, respectively.

As shown in FIG. 4, a plurality of the first ridges 86a are provided in the surface 14a of the first metal separator 14, for positioning the first membrane electrode assembly 16a relative to the first metal separator 14. The positions and the number of the first ridges 86a can be determined freely in correspondence with the outer shape of the first membrane electrode assembly 16a. For example, the first ridges 86a are formed integrally with the first seal member 46. The first seal member 46 includes an outer seal 46ₒᵤₜ positioned outside the first ridges 86a. The outer seal 46ₒᵤₜ is formed around, and contacts the flat surface of the second seal member 48 provided for the second metal separator 18.

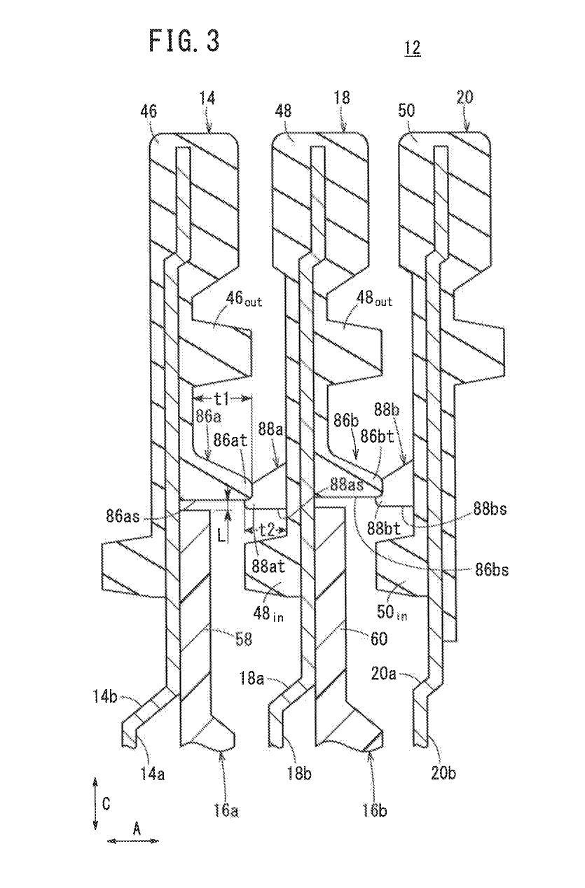

The first ridges 86a are elongated along the outer shape of the first membrane electrode assembly 16a. As shown in FIG. 3, each of the first ridges 86a has a right triangular shape in cross section, including a thin front end 86 at oriented toward the surface 18a of the second metal separator 18 and a vertical inner surface 86as.

As shown in FIG. 5, the second ridges 88a are provided in the surface 18a of the second metal separator 18, for blocking movement of the first membrane electrode assembly 16a beyond the first ridges 86a. The second ridges 88a correspond to the outer shape of the first membrane electrode assembly 16a. The second ridges 88a are positioned adjacent to the first ridges 86a along the outer shape of the first membrane electrode assembly 16a. For example, the second ridges 88a are formed integrally with the second seal member 48. The second seal member 48 includes an inner seal 48ᵢₙ positioned on the inside of the second ridges 88a. The inner seal 48ᵢₙ is formed around, and contacts the flat surface of the first resin frame member 58 provided for the first membrane electrode assembly 16a.

The second ridges 88a extend along the outer shape of the first membrane electrode assembly 16a. As shown in FIG. 3, each of the second ridges 88a having a right triangular shape in cross section, including a thin front end 88 at oriented toward the surface 14a of the first metal separator 14 and a vertical inner surface 88as. The inner surface 88 as of the second ridge 88a is positioned on the inside of the inner surface 86 as of the first ridge 86a (on the power generation surface side) by a length L.

The height t1 of the first ridges 86a is larger than the height t2 of the second ridges 88a (t1>t2). This is for prevention of the excessive surface pressure which may be produced, e.g., when the first membrane electrode assembly 16a is sandwiched between the second ridges 88a and the first metal separator 14.

As shown in FIGS. 2, 3, and 5, a plurality of first ridges 86b are provided in the surface 18b of the second metal separator 18, for positioning the second membrane electrode assembly 16b relative to the second metal separator 18. The first ridges 86b have the same structure as the first ridges 86a. The constituent elements of the first ridges 86b that are identical to those of the first ridges 86a are labeled with the same reference numeral (with suffix t, s), and description thereof will be omitted. Further, the second seal member 48 has an outer seal 48ₒᵤₜ positioned outside the first ridges 86b. The outer seal 48ₒᵤₜ is formed around, and contacts the flat surface of the third seal member 50 provided for the third metal separator 20. The third seal member 50 includes an inner seal 50ᵢₙ positioned on the inside of the second ridges 88b. The inner seal 50ᵢₙ is formed around, and contacts the flat surface of the second resin frame member 60 provided for the second membrane electrode assembly 16b.

As shown in FIGS. 1 to 3 and 6, the second ridges 88b are provided in the surface 20a of the third metal separator 20, for blocking movement of the second membrane electrode assembly 16b beyond the first ridges 86b. The second ridges 88b have the same structure as the second ridges 88a. The constituent elements of the second ridges 88b that are identical to those of the second ridges 88a are labeled with the same reference numeral (with suffix t, s), and description thereof will be omitted.

Operation of the fuel cell 10 will be described below.

Firstly, as shown in FIG. 1, an oxygen-containing gas is supplied to the oxygen-containing gas supply passage 22a, and a fuel gas such as a hydrogen-containing gas is supplied to the fuel gas supply passage 24a. Further, a coolant such as pure water, ethylene glycol, or oil is supplied to the pair of the coolant supply passages 25a.

Thus, some of the oxygen-containing gas from the oxygen-containing gas supply passage 22a flows through the inlet buffer 62a into the first oxygen-containing gas flow field 26 of the first metal separator 14. Some of the remaining oxygen-containing gas from the oxygen-containing gas supply passage 22a flows into the second oxygen-containing gas flow field 38 of the second metal separator 18.

As shown in FIGS. 1 and 4, the oxygen-containing gas moves along the first oxygen-containing gas flow field 26 of the first metal separator 14 in the horizontal direction indicated by the arrow B, and the oxygen-containing gas is supplied to the cathode 54 of the first membrane electrode assembly 16a. The remaining oxygen-containing gas flows along the second oxygen-containing gas flow field 38 of the second metal separator 18 in the direction indicated by the arrow B, and the oxygen-containing gas is supplied to the cathode 54 of the second membrane electrode assembly 16b.

In the meanwhile, as shown in FIG. 1, the fuel gas from the fuel gas supply passage 24a flows through the supply holes 36a of the second metal separator 18, and the fuel gas is supplied to the inlet buffer 68a. The fuel gas flows through the inlet buffer 68a, and the fuel gas is supplied to the first fuel gas flow field 34 of the second metal separator 18.

Some of the fuel gas from the fuel gas supply passage 24a flows through the supply holes 44a of the third metal separator 20, and the fuel gas is supplied to the inlet buffer 80a. The fuel gas flows through the inlet buffer 80a, and the fuel gas is supplied to the second fuel gas flow field 42 of the third metal separator 20.

As shown in FIGS. 1 and 5, the fuel gas moves along the first fuel gas flow field 34 of the second metal separator 18 in the direction indicated by the arrow B, and the fuel gas is supplied to the anode 56 of the first membrane electrode assembly 16a. The remaining fuel gas moves along the second fuel gas flow field 42 of the third metal separator 20 in the direction indicated by the arrow B, and the fuel gas is supplied to the anode 56 of the second membrane electrode assembly 16b.

Thus, in each of the first membrane electrode assembly 16a and the second membrane electrode assembly 16b, the oxygen-containing gas supplied to the cathode 54, and the fuel gas supplied to the anode 56 are consumed in electrochemical reactions at catalyst layers of the cathode 54 and the anode 56 for generating electricity.

Then, the oxygen-containing gas supplied to and partially consumed at each of the cathodes 54 of the first membrane electrode assembly 16a and the second membrane electrode assembly 16b flows through the outlet buffers 62b, 74b, and the oxygen-containing gas is discharged into the oxygen-containing gas discharge passage 22b.

The fuel gas supplied to and partially consumed at each of the anodes 56 of the first membrane electrode assembly 16a and the second membrane electrode assembly 16b flows through the outlet buffers 68b, 80b, and the fuel gas is discharged through the discharge holes 36b, 44b into the fuel gas discharge passage 24b.

In the meanwhile, as shown in FIG. 1, the coolant supplied to the pair of coolant supply passages 25a flows into the coolant flow field 32. The coolant from each of the coolant supply passages 25a is supplied to the coolant flow field 32. The coolant temporarily flows inward in the direction indicated by the arrow C, and then, the coolant moves in the direction indicated by the arrow B to cool the first membrane electrode assembly 16a and the second membrane electrode assembly 16b. After the coolant moves outward in the direction indicated by the arrow C, the coolant is discharged into the pair of coolant discharge passages 25b.

Next, operation of assembling the power generation unit 12 will be described.

Firstly, as shown in FIG. 3, the first membrane electrode assembly 16a is stacked on the first metal separator 14, the second metal separator 18 is stacked on the first membrane electrode assembly 16a, the second membrane electrode assembly 16b is stacked on the second metal separator 18, and the third metal separator 20 is stacked on the second membrane electrode assembly 16b. The first membrane electrode assembly 16a is positioned using the first ridges 86a provided in the surface 14a of the first metal separator 14.

In this regard, if any warpage is present in the first resin frame member 58 of the first membrane electrode assembly 16a, the end of the first resin frame member 58 may move over the first ridges 86a.

In an attempt to address the problem, in the embodiment of the present invention, the second ridges 88a are provided in the surface 18a of the second metal separator 18. The second ridges 88a protrude toward the surface 14a of the first metal separator 14, and the second ridges 88a are provided adjacent to the first ridges 86a (where the second ridges 88a are not overlapped with the first ridges 86a). In the structure, movement of the first membrane electrode assembly 16a beyond the first ridges 86a is blocked by the second ridges 88a, and the first membrane electrode assembly 16a is positioned by the first ridges 86a.

Further, the inner surfaces 88 as of the second ridges 88a are positioned on the inside of the inner surface 86 as of the first ridge 86a (on the power generation side) by the length L. In the structure, the first membrane electrode assembly 16a contacts the second ridges 88a, and never protrudes outward beyond the first ridges 86a.

Further, each of the first ridges 86a has a right triangular shape in cross section, including the thin front end 86 at and the vertical inner surface 86as. In the structure, when a load (tightening load) is applied to the power generation units 12 in the stacking direction, no excessive surface pressure is applied to the first ridges 86a. Likewise, each of the second ridges 88a has a right triangular shape in cross section, including the thin front end 88 at and the vertical inner surface 88as. In the structure, when a load (tightening load) is applied to the power generation units 12 in the stacking direction, no excessive surface pressure is applied to the second ridges 88a.

Thus, with the simple structure, the first membrane electrode assembly 16a can be positioned relative to the first metal separator 14 and the second metal separator 18 accurately and reliably.

Further, in the same manner as in the case of the first membrane electrode assembly 16a, the second membrane electrode assembly 16b is positioned between the second metal separator 18 and the third metal separator 20 accurately and reliably.

In the power generation unit 12, after the first membrane electrode assembly 16a and the second membrane electrode assembly 16b are positioned, for example, calking treatment is applied to the first metal separator 14, the second metal separator 18, and the third metal separator 20. In the calking treatment, for example, the entire power generation unit 12 is temporarily fixed by welding of the resin materials.

After the calking treatment is applied only, a plurality of the power generation units 12 are stacked together using knock pins (not shown) to form the fuel cell stack. At the time of handling the temporarily fixed power generation units 12, gaps tend to be formed inside the power generation units 12 because components of the power generation units 12 are not firmly fixed together. Therefore, as shown in FIG. 3, components such as the first metal separator 14, the second metal separator 18, and the third metal separator 20 may be separated from one another.

In this regard, in the embodiment of the present invention, the second ridges 88a are provided in the surface 18a of the second metal separator 18. The second ridges 88a protrude toward the surface 14a of the first metal separator 14. In the structure, even if warpage or the like occurs in the first resin frame member 58 of the first membrane electrode assembly 16a, movement of the first resin frame member 58 beyond the first ridges 86a is blocked by the second ridges 88a.

Accordingly, in the power generation units 12, operation such as separation of the portion where calking is applied to remove the first membrane electrode assembly 16a which has moved onto the first ridges 86a becomes unnecessary. Consequently, improvement in the operation of assembling the power generation unit 12 is achieved significantly. Also in the second membrane electrode assembly 16b, the same advantages as in the case of the first membrane electrode assembly 16a are achieved.

In the embodiment of the present invention, so called skip cooling structure having two MEAs and three separators (structure without any coolant flow field between the first membrane electrode assembly 16a and the second membrane electrode assembly 16b in one power generation unit 12) is adopted. However, the present invention is not limited in this respect. For example, the present invention is applicable to a power generation unit having structure where one MEA is sandwiched between a pair of separators (where cooling structure is provided for each cell). Further, though the resin frame equipped MEA is used in the embodiment of the present invention, the present invention is not limited in this respect. The present invention is also applicable to MEAs without any resin frame member.

While the invention has been particularly shown and described with reference to the preferred embodiment, it will be understood that variations and modifications can be effected thereto by those skilled in the art without departing from the scope of the invention as defined by the appended claims.

What is claimed is:

1. A fuel cell formed by stacking an electrolyte electrode assembly between a first separator and a second separator, the electrolyte electrode assembly including a pair of electrodes and an electrolyte interposed between the electrodes,
wherein the first separator includes a first ridge protruding toward the second separator, for positioning the electrolyte electrode assembly; and
the second separator includes a second ridge protruding toward the first separator, for limiting movement of the electrolyte electrode assembly.

2. The fuel cell according to claim 1, wherein the second ridge is provided on an inside of the first ridge.

3. The fuel cell according to claim 1, wherein the first ridge and the second ridge are provided adjacent to each other along an outer shape of the electrolyte electrode assembly.

4. The fuel cell according to claim 1, wherein the first ridge has a right triangular shape in cross section, including a thin front end oriented toward the second separator and a vertical inner surface.
